(19) United States
(12) Patent Application Publication
(10) Pub. No.: US 2003/0150860 A1
(43) Pub. Date: Aug. 14, 2003

(54) Structure of top cap for containers

(76) Inventor: Yu-Kang Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/072,919

(22) Filed: Feb. 12, 2002

(51) Int. Cl. A47J 36/06; B65D 25/28

(52) U.S. Cl. 220/212.5; 220/377; 220/912

(57) ABSTRACT

The invention relates to the structure of top cap for metal containers, particularly to the cap which is transparent in the middle part to make the foods or other objects therein seen clearly so that the container has the characteristics of metal and transparent plastic to add the value of the product.

### BACKGROUND OF THE INVENTION

The present invention relates to a top cap of a container, more particularly a top cap, which consists of metallic and plastic parts so as to be formed with the advantages of both plastic and metal.

Many containers used for holding small objects, dried fruits, cookies and so on take the form of a hollow cylinder, and are provided with a top cap. These containers, including the top caps, are usually made of plastic or metallic materials. Plastic containers have the advantage of being transparent or semitransparent, therefore the user can see the contents without having to open the top cap. However, plastics have a drawback of being easily scratched to become unpleasant to look at. In addition, being made of plastic, the container is likely to give people a cheap feeling.

Metallic containers have the advantages of both not being easily scratched and giving people a feeling of high quality and value. However, the user either has to stick a tag to the container or open the top cap for him to know what is contained in the container, causing him inconvenience.

### SUMMARY OF THE INVENTION

Therefore, it is a main object of the present invention to provide a container, of which the top cap consists of metallic and plastic parts so as to have the advantages of both.

It is a second object of the present invention to provide a top cap for a container, of which a plastic part and a metallic part can be securely combined together.

It is a third object of the present invention to provide a top cap consisting of metallic and plastic parts with ornamental elements in the plastic parts such that the container can look more attractive.

It is a fourth object of the present invention to provide a containers and a top cap of the container such that the top cap can be securely and tightly held on the container.

The top cap has a main part, and a pair of covering parts. The covering parts are respectively disposed on an upper, and a lower sides of an annular engaging portion of the main part with a screw being passed through central holes thereof. The covering parts are made of transparent materials, while the holding part and the main parts are made of metals.

### BRIEF DESCRIPTION OF THE DRAWINGS

The present invention will be better understood by reference to the accompanying drawings, wherein:

FIG. 1 is a perspective view of the top cap and the holding part according to the present invention.

FIG. 2 is an exploded perspective view of the container of the present invention.

FIG. 3 is a perspective view of the container of the present invention.

FIG. 4 is a side view of the container of the present invention.

FIG. 5 is a fragmentary cross-sectional view of the top cap of the present invention.

FIG. 6 is a view showing the use of the top cap of the present invention.

### DETAILED DESCRIPTION OF THE PREFERRED EMBODIMENTS

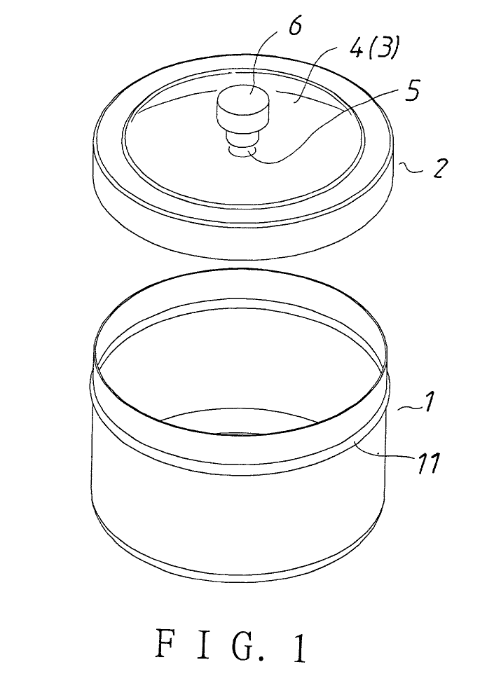

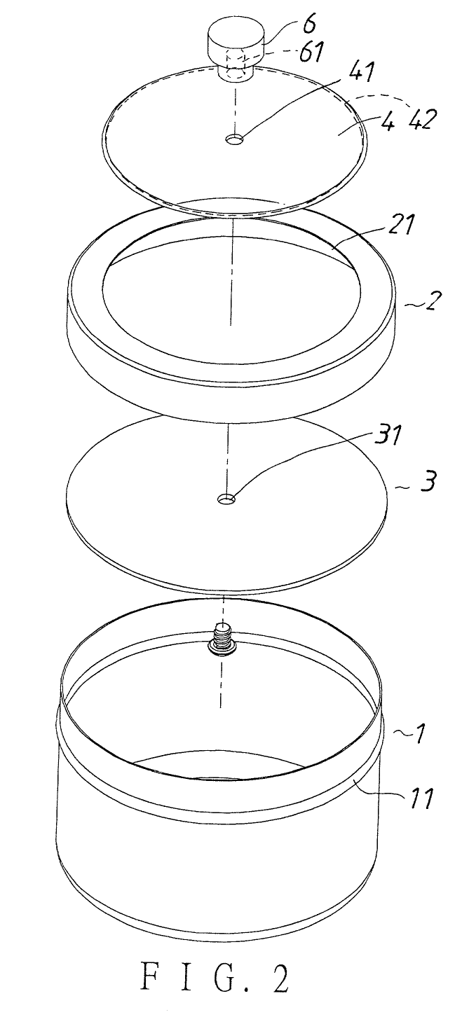

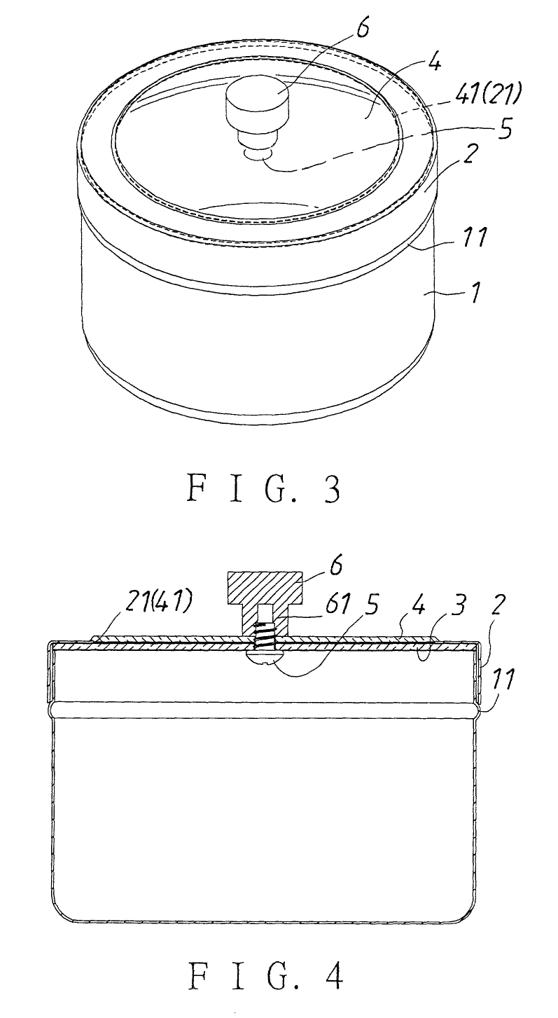

Referring to FIGS. 1, 2, and 3, a container of the present invention includes a hollow holding part 1 having a room therein, and a top cap 2.

The holding part 1 is made of metallic materials, and is formed with an outer annular protrusion 11.

The top cap 2 includes a metallic main part 21, an upper transparent covering part 4, a lower transparent covering part 3, and a held button 6. The metallic part 21 can be made of same material as the holding part 1, and is provided with annular engaging portion on an inner side of an upper edge thereof. The upper, and the lower transparent parts 4, 3 have central through holes 41 and 31 respectively. The held button 6 has a screw hole 61 on a lower portion thereof. The lower transparent part 3 is formed with such a shape and size that same can tightly come into contact with the bottom of the annular engaging portion, and the inner side of the metallic part 21 when same is fitted to the metallic part 21. The upper transparent part 4 is slightly bigger than the inner edge of the annular engaging portion.

In combination, the upper, and the lower transparent parts 4 and 3 are fitted to the upper, and the lower sides of the annular engaging portion of the metallic part 21 with the through holes 41, 31 being aligned with each other. A screw (not numbered) is passed through the through holes 31, 41, and screwed into the screw hole 61 of the held button 6; thus, the transparent parts 4, 3 are securely connected to the metallic part 21.

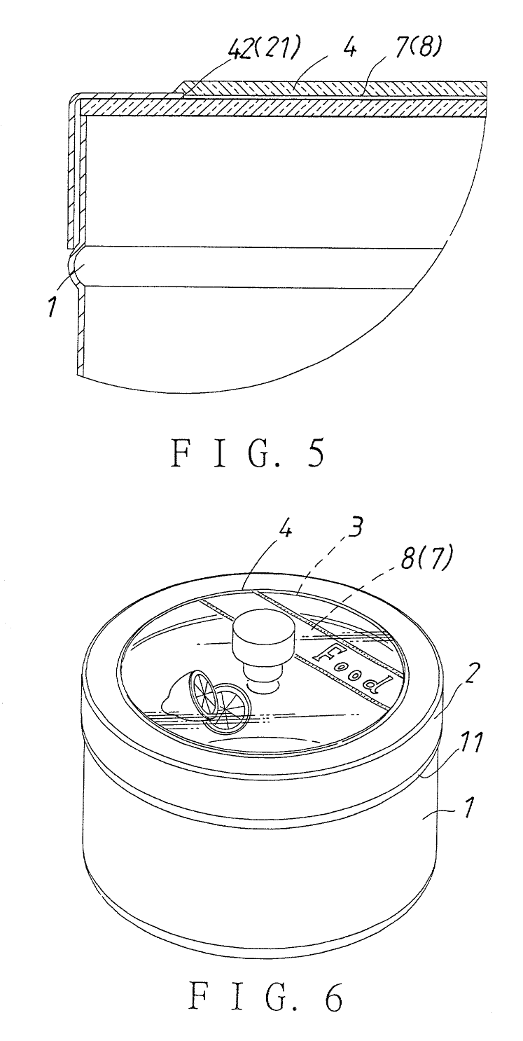

In addition, referring to FIG. 5, the upper transparent part 4 is formed with an annular recess 42 at the outer edge of the bottom such that same can further firmly fitted to the annular engaging portion of the metallic part 2; the depth of the recess 42 is preferably smaller than one half of the thickness of the annular engaging portion of the part 2.

Referring to FIG. 6, ornamental objects such as tags and stereoscopic designs and drawings are disposed between the upper and the lower transparent parts 4, 3 so as to make the top cap more attractive.

When the top cap 2 is placed on the upper portion of the holding part, the lower edge of the metallic part 21 will come into contact with the outer annular protrusion 11 of the holding part 1 to form a tight connection therewith.

From the above description, it can be easily seen that the top cap of the present invention has the advantage of both metal and a transparent material, i.e. not being easily scratched and capable of emitting a feeling of high quality and value at the metallic portions plus allowing the user to see the contents of the container through the transparent parts without having to open the top cap.

What is claimed is:

1. A top cap of a container, comprising
a main part, and a pair of covering parts; said covering parts being respectively disposed on an upper, and a lower sides of an annular engaging portion of said main part with a screw passing through central holes of both to be screwed into a held button disposed on an upper one of said covering parts; said top cap being removably placed onto an upper portion of a holding part.

2. The top cap of a container as claimed in claim 1, wherein said upper covering part has an annular recess formed on an outer edge of a bottom thereof to be mounted onto an outer side of an edge of said annular engaging portion of said main part.

3. The top cap of a container as claimed in claim 1, wherein said recess has a depth smaller than one half of a thickness of said annular engaging portion.

4. The top cap of a container as claimed in claim 1, wherein said holding part and said main part of said top cap are made of metallic materials, while said covering parts are made of transparent materials.

5. The top cap of a container as claimed in claim 1, wherein tags and ornamental objects are placed between said covering parts.

6. The top cap of a container as claimed in claim 1, wherein said holding part has an annular protrusion on an outer side thereof for allowing a lower edge of said main part to come into contact therewith when said top cap is placed onto said holding part.
